(19) United States
(12) Patent Application Publication
(10) Pub. No.: US 2026/0245047 A1
(43) Pub. Date: Aug. 20, 2026

(54) ELECTRONIC SYSTEM PROVIDING NONCOMPLYING FEATURE DETECTION AND CORRECTIVE ACTION RECOMMENDATIONS

(71) Applicant: MOTOROLA MOBILITY LLC, WILMINGTON, DE (US)

(72) Inventors: AMIT KUMAR AGRAWAL, BANGALORE (IN); NAKUL PATEL, NAGPUR (IN); KRISHNAN RAGHAVAN, BANGALORE (IN)

(21) Appl. No.: 19/054,824

(22) Filed: Feb. 15, 2025

(51) Int. Cl. G06Q 10/20; G06Q 10/1093; G06T 7/20; G06V 10/74

(52) U.S. Cl. CPC G06Q 10/20; G06Q 10/1093; G06T 7/20; G06V 10/761; G06V 2201/07

(57) ABSTRACT

An electronic system provides various techniques for identifying noncomplying features of tracked objects and recommending corrective actions to a user. The electronic system identifies, based on a comparison with image(s) within an image repository of tracked objects, at least one tracked object contained in an image received from an image capturing device having a field of view. In response to identifying the at least one tracked object, the electronic device compares features of the image of the at least one tracked object to a baseline image for the at least one tracked object. In response to identifying a noncomplying feature of the image from the baseline image, the electronic device selects a corrective action to associate with the noncomplying feature. The electronic device generates and outputs, to at least one output device, a first notification including the corrective action to the noncomplying feature.

### BACKGROUND

### 1. Technical Field

The present disclosure relates generally to electronic devices with cameras for capturing images, and more particularly to electronic devices capable of performing object recognition of contents of a camera image.

### 2. Description of the Related Art

Portable electronic devices such as smartphones, tables, laptops, and extended reality (XR) heads up display (HUD) are operated by users for a myriad of services and functions such as office automation, communication, entertainment, and location services. In an example, the services and functions may include scheduling reminders, performing person-to-person communication, facilitating a financial transaction, tracking user activities, etc. Portable electronic devices are also typically configured with cameras and components and/or functional modules that allow the device to process and present visual images and information, such as displaying an image preview captured by a camera or other image capturing device.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1A presents a functional block diagram of example components of an electronic device in a communication environment and having hardware and software components that enable the features of the present disclosure to be advantageously implemented, according to one or more embodiments;

FIG. 1B is an additional block diagram representation of the electronic device of FIG. 1A presenting additional components, including components for wireless communications with other devices, according to one or more embodiments;

FIG. 2A is a simplified block diagram of operative components and example implementation of a damage detection/repair recommendation (DDRR) no-electronic system comprising the electronic device and augmented reality (AR) device for processing and identifying noncomplying features of objects in a camera image and outputting a corrective action to the noncomplying features, according to one or more embodiments;

FIG. 2B illustrates an alternate implementation of a DDRR electronic system that includes the electronic device with an integral display, according to one or more embodiments;

FIG. 3 illustrates a display of the electronic device presenting a camera preview of a tracked object with notifications of noncomplying features including assessments for severity and recommended corrective actions, according to one or more embodiments;

FIG. 4 illustrates the display of the electronic device presenting recommended do-it-yourself repair procedures for accomplishing a particular recommended corrective action, according to one or more embodiments;

FIG. 5 illustrates the display of the electronic device presenting recommended providers of a particular recommended corrective action, according to one or more embodiments;

FIG. 6A illustrates a transmissive display of the AR device of the electronic system presenting notifications overlaid on a field of view of tracked objects, according to one or more embodiments;

FIG. 6B illustrates a display of the electronic device presenting the notification on a camera image preview of the tracked objects, according to one or more embodiments;

FIGS. 7A-7B (collectively “FIG. 7”) is a flow diagram presenting a computer-implemented method for recognizing nonconforming or noncomplying features of objects tagged for monitoring and for recommending corrective actions to a user to address the noncomplying features, according to one or more embodiments;

FIGS. 8A-8B (collectively “FIG. 8”) is a flow diagram presenting computer-implemented method 800 augmenting the method 700 of FIG. 7 with a plurality of techniques for recognizing noncomplying features and recommending corrective actions via an AR device, according to one or more embodiments; and

FIGS. 9A-9B (collectively “FIG. 9”) is a flow diagram presenting a computer-implemented method augmenting the method 800 of FIG. 8 with techniques for selecting a corrective action and generating a notification indicating the corrective action.

### DETAILED DESCRIPTION

According to aspects of the present disclosure, an electronic system, a method, and a computer program product provide various techniques for recognizing nonconforming or noncomplying features (e.g., improper installation, damage) of objects tagged for monitoring and for recommending corrective actions to a user to address the nonconforming/noncomplying features. Despite advancements in digital reminders and automation, there remains a significant gap in addressing tasks that require manual attention and that are not digitally linked to automated transactions. The user may not be sufficiently observant or knowledgeable to identify the noncomplying feature. Alternatively, or in addition, the user may be insufficiently knowledgeable to know the corrective action required for the noncomplying feature. In an example, the user may not know a repair procedure that is the corrective action. In another example, the user may not know a provider of the repair procedure, or a particular provider of the repair procedure that should be contacted. Everyday occurrences such as a dent in a car, a punctured bicycle tire, or a fence that needs painting are often overlooked by a user and are not automatically addressed by reminder systems. Similarly, household chores such as mowing the lawn, cleaning gutters, or fixing a leaky faucet do not automatically prompt digital notifications. These tasks require a human touch and are not automated or scheduled through digital platforms. Unlike subscription renewals or bill payments, which are tied to specific dates or intervals, these tasks often arise unexpectedly and may demand immediate attention. The unexpectedness and rarity of certain events tend to make these events easy to overlook, resulting eventually in an inconvenient situation or even severe consequences.

Even if a user recognizes the need to address these unexpected tasks, the user may be unable to understand or identify the exact issue and the severity of the issue. The user may not know the corrective actions that may be done by the user or by a provider of services such as repair services. The user may not know which provider of services is available, close at hand, highly ranked, and/or is competitively priced. In an example, unlike the seamless integration of digital services such as grocery delivery or online bill payment, finding reliable and affordable assistance for tasks such as car repairs or home maintenance often involves extensive research and comparison. Thus, despite our increasing reliance on digital solutions for managing our lives, there remains a persistent divide between the digital and real-world spheres. Only by integrating digital convenience with real-world necessities can we truly streamline the management of our daily tasks and responsibilities.

The present disclosure may utilize extended Reality (XR) features to provide the bridge to the aforementioned real-world detection of non-compliant issues. XR refers to all real-and-virtual combined environments and human-machine interactions generated by computer technology and wearables. XR is an umbrella term for different types of realities including Virtual reality (VR), Augmented reality (AR), and Mixed reality (MR), and the areas interpolated among them. The levels of virtuality range from partially sensory inputs to fully immersive VR. A key aspect of XR is the extension of human experiences, especially those relating to the senses of existence (represented by VR), and the acquisition of cognition (represented by AR).

According to one or more embodiments, an electronic system includes an image capturing device having a field of view, and a memory having a repair condition detection and repair recommendation (RCDRR) module and an image repository of tracked objects. A processor is communicatively coupled to the image capturing device and the memory. The processor is configured to cause the electronic system to receive an image from the image capturing device having a field of view. The processor is configured to cause the electronic system to identify, based on a comparison with image(s) within the image repository of tracked objects, at least one tracked object contained in an image received from the image capturing device. In response to identifying the at least one tracked object, the processor causes the electronic system to compare features of the image of the at least one tracked object to a baseline image for the at least one tracked object. In response to identifying a noncomplying feature of the image from the baseline image, the processor causes the electronic system to select a corrective action to associate with the noncomplying feature. The processor is configured to cause the electronic system to generate and output to at least one output device, a first notification of the noncomplying feature, including the corrective action to the noncomplying feature.

According to one or more embodiments, a computer-implemented method is provided for identifying noncomplying features of tracked objects and recommending corrective actions to a user. The method includes identifying, based on a comparison with one or more images within an image repository of tracked objects, at least one tracked object contained in an image received from an image capturing device having a field of view. In response to identifying the at least one tracked object, the method includes comparing features of the image of the at least one tracked object to a baseline image for the at least one tracked object. In response to identifying a noncomplying feature of the image from the baseline image, the method includes selecting a corrective action to associate with the noncomplying feature. The method includes generating and outputting to at least one output device, a first notification comprising the corrective action to the noncomplying feature.

Further embodiments provide a computer program product that includes: a non-transitory computer readable medium; and program code on the computer readable medium that, when processed by a processor of an electronic system, configures the processor and/or the electronic system to perform functions of the above-described method.

The above contains simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the figures and the remaining detailed written description. The above as well as additional objectives, features, and advantages of the present disclosure will become apparent within the following detailed description.

In the following description, specific example embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized, and that logical, architectural, programmatic, mechanical, electrical and other changes may be made without departing from the general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various aspects are described which may be aspects for some embodiments but not other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc., do not denote any order or importance, but rather the terms first, second, etc. are used to distinguish one element from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest interpretation given the context in which that term is utilized.

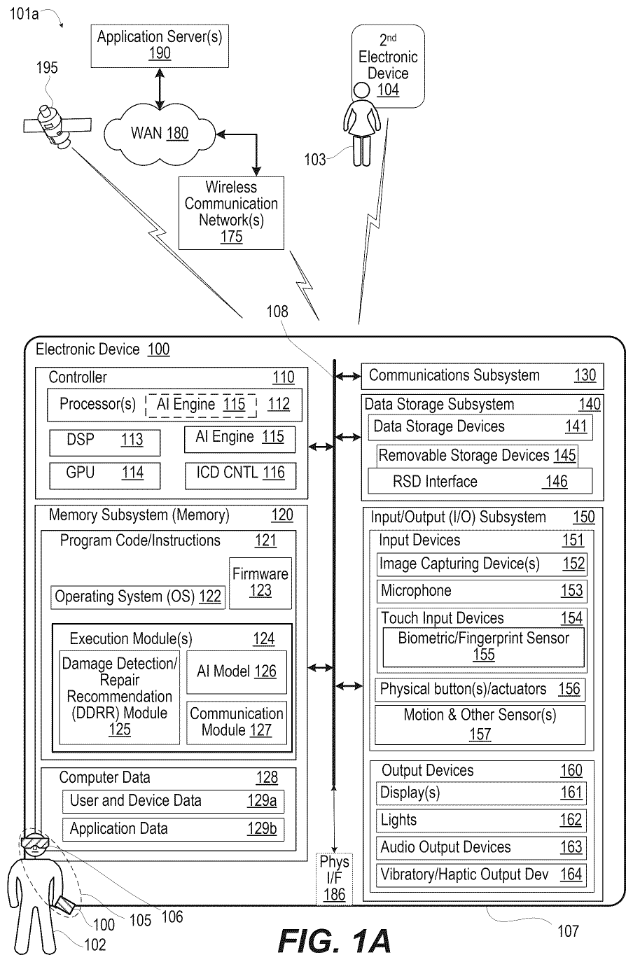

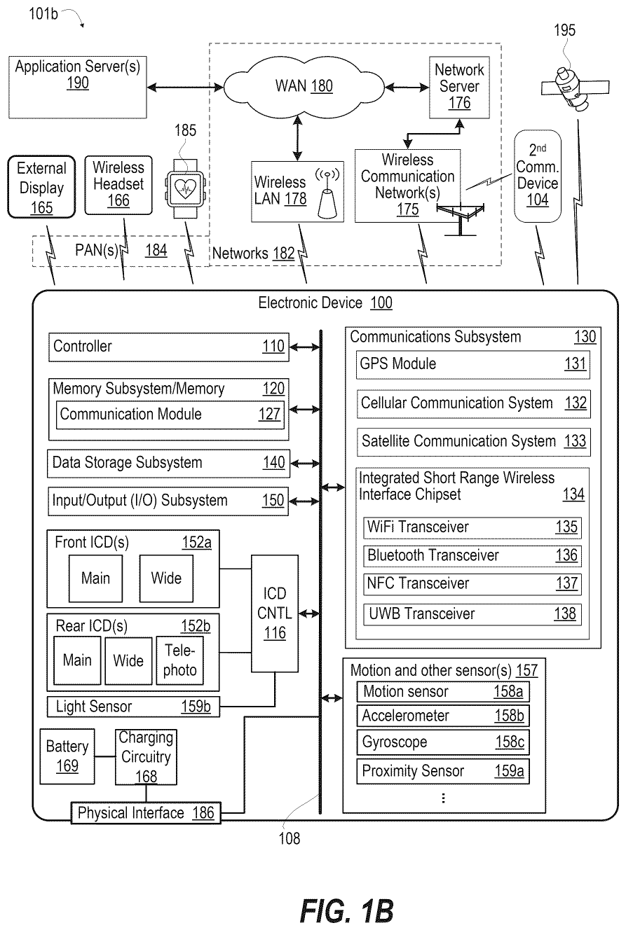

Those of ordinary skill in the art will appreciate that the hardware components and basic configuration depicted in the following figures may vary. For example, the illustrative components within electronic device 100 (FIG. 1A-1B) are not intended to be exhaustive, but rather are representative to highlight components that can be utilized to implement the present disclosure. For example, other devices/components may be used in addition to, or in place of, the hardware depicted. The depicted example is not meant to imply architectural or other limitations with respect to the presently described embodiments and/or the general disclosure.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural, functional, operational, or otherwise) on the described embodiments.

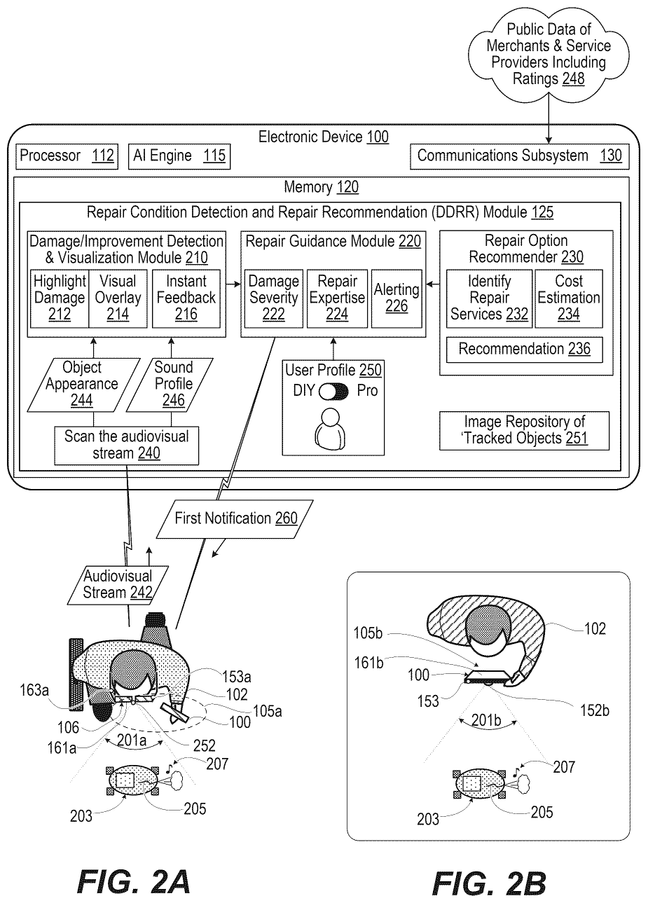

Referring now to the figures and beginning with FIG. 1A, there is illustrated a block diagram of an example electronic device 100 in communication environment 101a and having hardware and software components, which enable the features of the present disclosure to be advantageously implemented, according to one or more embodiments. Examples of electronic device 100 can include, but are not limited to, mobile devices, a notebook computer, a mobile phone, a smart phone, a digital camera with enhanced processing capabilities, a smart watch, a tablet computer, a heads up display (e.g., smart glasses) worn by user 102, and other types of electronic devices. For purposes of this disclosure, electronic device is assumed to be a communication device that can be used to communicate with second user(s) 103 who use corresponding second electronic device(s) 104. Electronic device 100 can therefore be interchangeably referred to herein as communication device 100. In an example, in performing aspects of the present disclosure, electronic device 100 may operate as part of electronic system 105 that includes an external display such as AR device 106. In one or more embodiments, in performing aspects of the present disclosure, electronic system 105 may only include electronic device 100. Examples of these alternate embodiments are described below respectively with regard to FIGS. 2A-2B.

Electronic device 100 generally includes controller 110, memory (or memory subsystem) 120, communication subsystem 130, data storage subsystem 140, input/output subsystem 150, all contained within or extended from an exterior surface of device housing 107. Controller 110 is shown communicatively connected/coupled via system interlink 108 with each of the subsystems 120, 130, 140, and 150, and is directly or indirectly connected with the individual components within each subsystem 120, 130, 140, and 150. System interlink 108 represents internal components that facilitate internal communication by way of one or more shared or dedicated internal communication links, such as internal serial or parallel buses. As utilized herein, the term “communicatively coupled” means that information signals are transmissible through various interconnections, including wired and/or wireless links, between the components. The interconnections between the components can be direct interconnections that include conductive transmission media or may be indirect interconnections that include one or more intermediate electrical components.

Controller 110 includes processor 112, which includes one or more central processing units (CPUs) or data processors. Processor 112 performs many of the features of controller 110 and references to features performed by controller 110 can be interchangeably referred to herein as features of processor 112, and vice-versa. In some embodiments, the various functions associated with controller 110 are integrated into processor 112, and accordingly, references made herein to controller and/or processor are understood to refer to one or both components as providing a single management component within the electronic device 100. For simplicity in describing the features of the electronic device 100, the operational functions provided by one or more of operational components within controller 110, including those provided by processor 112 are collectively described as being performed by controller 110. Collectively, components integrated within controller 110 support computing, classifying, processing, transmitting and receiving of data and information, and presenting of graphical and photographic images within a display.

As illustrated, controller 110 can also include one or more digital signal processors 113, graphics processing units (GPUs) 114, artificial intelligence (AI) engine 115, and image capturing device (ICD) controller 116. In some embodiments, the functionality of each of these additional processing components can be integrated with processor(s) 112. For example, processor 112 can, in some embodiments, include dedicated AI engine 115 and image signal processors (ISPs) (not shown). Processor 112 can further include other processors such as auxiliary processor(s) that may act as a low power consumption, always-on sensor hub for physical sensors.

Controller 110 manages, and in some instances directly controls, the various functions and/or operations of electronic device 100. These functions and/or operations include, but are not limited to including, application data processing, communication, location and navigation tasks, image processing, and signal processing. In one or more alternate embodiments, electronic device 100 may use hardware component equivalents for application data processing and signal processing. For example, electronic device 100 may use special purpose hardware, dedicated processors, general purpose computers, microprocessor-based computers, micro-controllers, optical computers, analog computers, dedicated processors and/or dedicated hard-wired logic. Controller 110 can, in some embodiments, also include a hardware acceleration (HA) unit, which can establish direct memory access (DMA) sessions to route network traffic to various elements within electronic device 100 without direct involvement from processor 112 and/or a device operating system 122.

Memory subsystem (or memory) 120 may include a combination of volatile and non-volatile memory, such as random-access memory (RAM) and read-only memory (ROM). Memory subsystem 120 stores instruction or program code 121 for execution by processor 112 to configure processor 112 (and more generally electronic device 100) to provide the operational functions and features described herein. Instructions/program code 121 (or program code 121 for short) includes instructions for an operating system (OS) 122, firmware 123, such as basic input/output system (BIOS) or Uniform Extensible Firmware Interface (UEFI). Program code 121 includes execution module(s) 124 that collectively provides the various features of the disclosure. Execution module(s) 124 include, without limitation, damage detection/repair recommendation (DDRR) module 125, which provides the features and operating functionality of the disclosed embodiments when the corresponding program instructions of DDRR module 125 are processed by/within processor 112/controller 110.

Execution modules 124 further includes AI model(s) 126. In one or more embodiments, processor 112 can utilize AI models 126 to provide AI functionality of processor-integrated AI engines 115. In other embodiments, AI models 126 are directly utilized by AI engine 115. In one or more embodiments, AI model 126 is integrated as a sub-module within DDRR module 125 and is trained to support the AI features of DDRR module 125. AI model(s) 126 may include an artificial neural network, a decision tree, a support vector machine, Hidden Markov model, linear regression, logistic regression, Bayesian networks, and so forth. AI model(s) 126 can be individually trained to perform specific tasks and can be arranged in different sets of AI models to generate different types of output. Training of AI model(s) 126 is the process by which AI models are trained to perform specific tasks or achieve certain objectives. The training involves providing the model with a large amount of data and allowing the model to learn from patterns and relationships within that data.

Each of the above-introduced module(s) and/or application(s) provides program instructions/code that are processed by processor 112 and which configures processor 112 (and/or controller 110) and/or other operational components of electronic device 100 to cause the electronic device 100 to perform specific operations and functions, as described herein. Descriptive names assigned to these modules add no functionality and are provided solely to assist in identifying the underlying features performed by processing the different modules. For example, DDRR module 125 can include program instructions for identifying nonconforming or noncomplying features (e.g., improper installation, damage, incorrect placement, non-compliance with monitored compliance settings, notifications of failure/errors, abnormal operating sound, etc.) of objects tagged for monitoring. Noncomplying features may include overloading of an item (e.g., excess physical weight or size such placed in a washing machine. In another example, the noncomplying feature may be plugging too many electronic items into a charging device or outlet with specific voltage rating. One electrical item may demand too much from a power strip, for example. In a further example, identification of fault notification may include recognizing what indications are provided by a particular type of object. A flashing light may indicate a problem that a user may not recognize without assistance. Additionally, DDRR module 125 can include program instructions that associate recommended corrective actions to a user to address the noncomplying features. Other features provided by DDRR module 125 are described in further detail throughout this disclosure.

Program code 121 can further include instructions/code for other applications (not shown) providing different features of/within electronic device 100. In one or more embodiments, program code 121 may be integrated into a distinct chipset or hardware module as firmware that operates separately from other executable program code. Portions of program code 121 may be incorporated into different hardware components that operate in a distributed or collaborative manner.

Memory subsystem 120 also includes computer data 128. During execution of program code 121, processor 112 may access, use, generate, modify, store, or communicate computer data 128, such as user and device data 129a and application data 129b. Computer data 128 may incorporate “data” that originated as raw, real-world “analog” information that consists of basic facts and figures. Computer data 128 includes different forms of data, such as numerical data, images, coding, notes, and financial data, as well as data presenting video, graphics, text, and images. Computer data 128 may originate at electronic device 100 or may be retrieved from a remote device via communications subsystem 130. Electronic device 100 may store, modify, present, or transmit computer data 128.

Communications subsystem 130 includes various components that enable electronic device 100 to communicate with external communication networks and other devices, such as second electronic device 104 and application server(s) 190, etc., via communications subsystem 130. According to one or more embodiments, communication module 127 presented within program code 121 includes instructions supporting the use of communications subsystem 130 to establish communication interfaces enabling communication by electronic device 100 with these external networks and devices.

Data storage subsystem 140 of electronic device 100 includes data storage device(s) 141. Controller 110 is communicatively connected, via system interlink 108, to data storage device(s) 141. Data storage subsystem 140 provides stored versions of program code 121 and computer data 128 on nonvolatile storage that is accessible by controller 110. The program code 121 can be loaded into memory 120 for execution/processing by controller 110. In one or more embodiments, data storage device(s) 141 can include hard disk drives (HDDs), optical disk drives, and/or solid-state drives (SSDs), etc.

Data storage subsystem 140 of electronic device 100 can include removable storage device(s) (RSD(s)) 145, which is received in RSD interface 146. Controller 110 is communicatively connected to RSD 145, via system interlink 108 through RSD interface 146. In one or more embodiments, RSD 145 is a non-transitory computer program product or computer readable storage device that stores program code and associated data, including a copy of DDRR module 125 and AI model(s) 126, which may be executed by a processor associated with a user device, such as electronic device 100. Controller 110 can access data storage device(s) 141 or RSD(s) 145 to provision electronic device 100 with stored program code 121 and computer data 128 that, when executed/processed by processor 112, the program code configures processor 112 and/or more generally electronic device 100, to provide the various functions described herein.

I/O subsystem 150 includes input devices 151 such as, but not limited to, image capturing device(s) (ICDs) 152, microphone 153, and touch input devices 154 (e.g., touch screens, keys, or buttons) for use by user 102 to interface with electronic device 100. Touch input devices 154 can include a biometric/fingerprint sensor 155 for biometric input. Biometric/fingerprint sensor 155 can be used to read/receive biometric data, such as fingerprints, to identify or authenticate a user. In some embodiments, the biometric sensor 155 can supplement an ICD (camera), which captures images for user detection/identification via facial recognition.

Input devices 151 may include physical buttons/actuators 156 that can be located on a periphery of the device housing 107. Physical buttons/actuators 156 may provide controls for volume, power, and ICDs 152. Microphone 153 can also be referred to as an audio input device. In some embodiments, microphone 153 may be used for identifying a user via voiceprint, voice recognition, and/or other suitable techniques. Input devices 151 can also include one or more motion or other sensor(s) 157, which are further defined in the FIG. 1B description which.

With reference to FIG. 1B, as illustrated, motion and other sensor(s) 157 of electronic device 100 include, but are not limited to, one or more motion sensor(s) 158a, one or more accelerometers 158b, one or more gyroscopes 158c, and proximity sensor 159a, etc. Motion sensor(s) 158a detects movement of electronic device 100 and provides motion data to processor 112 indicating the spatial orientation, position and movement of electronic device 100. Accelerometers 158b measure linear acceleration of movement of electronic device 100 in multiple axes (X, Y and Z). For example, accelerometers 158b can include three accelerometers, where one accelerometer measures linear acceleration in the X axis, one accelerometer measures linear acceleration in the Y axis, and one accelerometer measures linear acceleration in the Z axis. Accelerometers 158b can be used to calculate the orientation/position of electronic device 100 relative to the earth and can also be referred to as a gravity sensor. Gyroscope 158c measures rotation or angular rotational velocity of electronic device 100. Proximity sensor 159a senses the presence of nearby objects. In one embodiment, proximity sensor 159a can be an infrared (IR) sensor that detects the presence of a nearby object, such as when electronic device 100 is in a pocket of a user. Electronic device 100 can also include one or more light sensors 159b, which detects the luminance and/or intensity (i.e., the amount) of ambient light surrounding the electronic device 100.

Referring again to FIG. 1A, I/O subsystem 150 includes output devices 160 such as, but not limited to, display(s) 161, lights 162, audio output devices 163, and vibratory and/or haptic output devices 164. In one or more embodiments, electronic device 100 includes an integrated display 161 which incorporates a tactile, touch screen interface that can receive user's tactile/touch input. As a touch screen device, integrated display 161 allows a user to provide input to and/or to control electronic device 100 by touching features within a user interface presented on integrated display 161. Tactile, touch screen interface (154) can be utilized as an input device. The touch screen interface (154) can include one or more virtual buttons or selectable affordances. In one or more embodiments, when a user applies a finger or stylus on the touch screen interface (154) in the region demarked by the virtual button, the touch of the region causes the processor 112 to execute code to implement a function associated with the virtual button. In some implementations, integrated display 161 is integrated into a front surface of electronic device housing 107 along with front image capturing devices (not specifically shown), while the higher quality ICDs are located on a rear surface of device housing 107. Other embodiments provide multiple integrated displays within electronic device 100 and references to display(s) 161 are assumed to refer to one or all of these multiple integrated displays.

Vibration/haptic output device 164 can cause electronic device 100 to vibrate or shake when activated. Vibration/haptic output device 164 can be activated during an incoming call or message in order to provide an alert or notification to a user of electronic device 100. In one or more embodiments, integrated display 161, audio output devices (or speakers) 163, and vibration/haptic device 164 can generally and collectively be referred to as output devices.

With reference again to FIG. 1B and with continuing reference to FIG. 1A, there is presented another view of electronic device 100 with components enabling electronic device 100 to function as a mobile communication device, within an expanded communication environment 101b. In addition to the functional and operational components already presented by and described within the description of FIG. 1A, FIG. 1B further illustrates expanded communications subsystem 130 with additional communication components and interfaces enabling electronic device 100 to perform wireless communications within an expanded communication environment 101b that includes other devices.

Communications subsystem 130 includes global positioning system (GPS) module 131 that enables electronic device to communicate with and receive GPS location data from GPS satellite(s) 195. In one or more embodiments, GPS module 131 receives geospatial input from GPS broadcasts of time data and location data from GPS satellite(s) 195 to obtain geospatial location information about the physical location of electronic device 100.

In one or more embodiments, controller 110, via communications subsystem 130, performs multiple types of cellular over-the-air (OTA) or non-cellular wireless communication, such as by using a Bluetooth connection or other personal access network (PAN) connection. As shown, communications subsystem includes cellular communication system 132, which includes at least one radio frequency RF front end coupled to one or more antennas. In one or more embodiments, cellular communication system 132 can include a communication module with one or more baseband processors or digital signal processors, one or more modems, and a radio frequency (RF) front end having one or more transmitters and one or more receivers. In one or more embodiments, controller 110, via communications subsystem 130, may communicate via an OTA cellular connection with radio access networks (RANs) over a cellular wireless communication network (CWCN) 175. CWCN 175 can be a terrestrial network and include a plurality of base stations and associated network server(s) 176, in one embodiment. Cellular communication system 132 allows electronic device 100 to communicate wirelessly with CWCN 175 via transmissions of communication signals (represented as lightning bolts) to and from network communication devices, such as base stations or cellular nodes, of CWCN 175. Alternatively, or in addition, CWCN 175 can include a satellite network, and electronic device 100 connects to CWCN 175 using satellite communication system 133. Cellular communication system 132 and satellite communication system 133 enable electronic device 100 to engage in long distance wireless communication capabilities.

In one or more embodiments, communications subsystem 130 includes integrated short range wireless interface chipset 134 having one or more of Wi-Fi transceiver (TxRX) 135, Bluetooth (BT) TxRx 136, near field communication (NFC) transceiver 137, and ultra-wideband (UWB) transceiver 138. In one or more embodiments, the short-range communication devices are not integrated on a single chipset but can be separately provided hardware components. In one or more embodiments, electronic device 100 can communicate wirelessly with external wireless devices, such as a Wi-Fi router of a wireless local area network (WLAN) 178 and/or second electronic device 104, via one or more short-range wireless interface(s). Second electronic device 104 can be a communication device, such as a smartphone, and/or can be similarly configured as electronic device 100. Second user 103 may operate second electronic device 104. In one or more embodiments, electronic device 100 can receive Internet or Wi-Fi based calls, text messages, multimedia messages, and other notifications via a combination of wireless and wired networks (generally networks 182).

In one or more embodiments, networks 182 can include CWCN 175, WLAN 178, and Wide Area Network (WAN) 180, such as the Internet. In one or more embodiments, WAN 180 can enable electronic device 100 to access application servers 190, which can provide a downloadable version of DDRR module 125 and/or access to other applications, online transactions, and resources.

In one or more embodiments, networks 182 can also include personal area networks (PAN) 184, which are individually created with second devices via one of short-range wireless devices from among Wi-Fi TxRX 135, BT TxRx 136, NFC transceiver 137, and UWB transceiver 138. Example second devices include external display 165, wireless headset 166, and wearable computing device 185. External display 165 can be a stand-alone monitor/display or a display integrated into a second electronic device, such as a laptop computer. In at least one embodiment, connection to the external display 165 can be wired and can include an intermediate connection device, such as a docking station device. In one or more embodiments, wearable computing device 185, such as a smartwatch, fitness tracker, or the like, may be paired with electronic device 100, and provide biometric data such as heart rate, breathing rate, and the like, to the electronic device 100 via the paired communication link.

Electronic device 100 also includes a physical interface 186. Physical interface 186 of electronic device 100 can serve as an input/output data port and can be used as a power supply port that is coupled to charging circuitry 168 which feeds electrical power to device battery 169 to enable recharging of device battery 169 and/or powering of electronic device 100. As a data port, physical interface 186 can enable electronic device 100 to be physically coupled via a cable or docking station port to a second device, such as external display 165.

FIG. 1B also presents additional details of ICD(s) 152 of electronic device 100. Throughout the disclosure, the term image capturing device (ICD) is synonymous with and/or utilized interchangeably with any one of the cameras of electronic device 100. ICD(s) (or cameras) 152 includes front cameras 152a and rear cameras 152b. In one embodiment, each of front cameras 152a and rear cameras 152b are communicatively coupled to ICD controller 116. ICD controller 116 supports the processing of image data from front cameras 152a and rear cameras 152b. Front cameras 152a can include a main camera and a wide-angle camera. Rear ICDs cameras 152b can include a main camera, a wide-angle camera, and a telephoto camera. Both sets of cameras 152 include image sensors that can capture images that are within the field of view (FOV) of each respective camera 152. In one or more embodiments, one or more of the cameras can be utilized to enable biometric authentication using facial image and/or iris scan recognition.

FIG. 2A is a simplified block diagram of operative components and example implementation of damage detection/repair recommendation (DDRR) system 105a comprising electronic device 100 and AR device 106 for processing and identifying noncomplying features of objects in a camera image and outputting a corrective action to the noncomplying features. In one or more embodiments, DDRR system 105a includes some component variation of electronic device 100 incorporated in AR device 106 (e.g., heads up display or smart glasses) having transmissive display 161a that enables combining real-world imagery with virtual notifications. In one or more alternate embodiments, DDRR system 105a includes electronic device 100 and AR device 106 as separate devices that communicate via a wired or wireless connection. AR device 106 includes front image capturing device 203 (e.g., front ICD(s) 152a (FIG. 1B)) oriented to capture field of view 201a that is aligned with at least one transmissive display 161a configured to be aligned with eyes of user 102 when user 102 is wearing AR device 106. AR device 106 may include audio output device(s) 163a.

FIG. 2B illustrates alternate electronic system 105b with electronic device 100 having integral display 161b on a front side that can be viewed by user 102. Display 161b is integrated into one surface of the exterior body of electronic device. In an example, electronic system 105b is wholly constituted by electronic device 100. Electronic device 100 includes back image capturing device(s) 152b having field of view 201b that is opposite to display 161b. Images captured within the FOV of camera can be presented on display 161b when electronic device 100 is in display mode or DDRR notification mode. With reference to both FIGS. 2A-2B , both electronic system 105a (FIG. 2A) and electronic system 105b (FIG. 2B) allow for access to and use of a connected network of information. In addition to public data 248 (FIG. 2A), examples of the connected networks are provided in FIGS. 1A-1B. For clarity, in both FIGS. 2A-2B, tracked object 203 has features (e.g., surface area, shape, colors, components) that can be compared and matched to baseline images of the same tracked object 203 captured and stored from an earlier time or of the same type of object (e.g., manufactured model) from an online image source or an image captured of the similar object. Electronic system 105a (FIG. 2A) or electronic system 105b (FIG. 2B) may identify noncomplying feature(s) 205 of tracked object 203 based on identifying at least one small portion of tracked object 203 that does not match a baseline image for tracked object 203. In one or more embodiments, known failure modes, examples of damage, and defective assembly of objects similar to tracked object 203 may be captured in a datastore of nonstandard/noncomplying baseline images that may be used to identify noncomplying feature(s) 205. In one example, a visual indicator, such as a flashing light, or a change in color or luminance in an operating light attached to tracked object 203, may constitute a notification of a noncomplying feature 205 of tracked object 203.

In one or more embodiments, tracked object 203 may have an associated sound profile when operating correctly and may also be associated with a different sound profile, such as abnormal sound 207, which is an indication of noncomplying feature 205. In an example, abnormal sound 207 may result from a reduction in acoustic sound dampening, an escape of pressurized gas, a weakened structural housing, introduction of movement/vibrations to a stationary part/component, loss of lubrication resulting in squeaks or other sounds, etc.

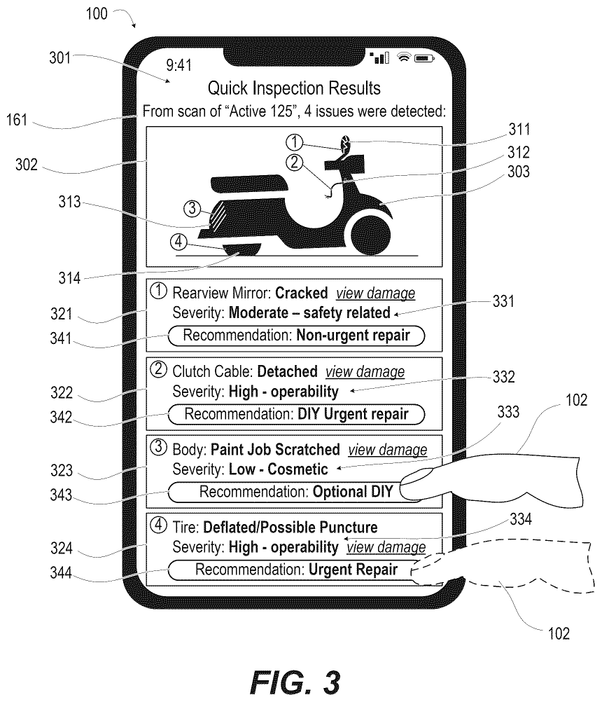

With particular reference to FIG. 2A, DDRR module 125 of electronic device 100 may include damage/improvement detection and visualization module 210, repair guidance module 220, and repair option recommender module 230. Processor 112 may cause DDRR module 125 to execute. DDRR module 125 may operate with assistance from, or incorporate, AI engine 115. The description of these features of DDRR module 125 are provided by processor execution of the program code of DDRR module 125, which may include features of AI engine 115, causing electronic device 100 and/or AR device 106 to perform the described features. DDRR module 125 may locally access one or more images, such as scan 240 of audiovisual stream 242 from image capturing device 152c that includes object appearance 244 (i.e., visual profile) and sound profile 246. DDR module 125 may also access public data 248 remote to electronic device 100 via communications subsystem 130. In an example, communications subsystem 130 may connect to public data 248 via communications networks (e.g., Internet) as described above in FIGS. 1A and 1B. Public data 248 may include baseline images, corrections actions associated with noncomplying features, descriptions of merchants and service providers, repair procedures, ratings of providers, etc. Memory 120 may include data describing capabilities of user 120, such as user profile 250 that indicates an expertise level (e.g., do-it-yourself (DIY), Pro, or novice) of user 120. Memory 120 may include data repository 251 of tracked objects 203 that includes baseline images and noncomplying baseline images such as retrieved from public data 248. In one or more embodiments, data repository 251 of tracked objects 203 may include locally obtained images of tracked object 203 when determined to be in a baseline condition for future comparisons. For example, in an always-on mode while within a specific geographic location (e.g., at home or workplace), electronic device 100 can detect a new device/object within the FOV of the AOC camera as the user moves through the space. The new device/object is added to a list of objects and the user asked if the object can be added to the list of baseline objects. When the user responds in the affirmative, the original image of the object is recorded as the baseline image for use during later evaluations for damages and non-compliance. Additional details about the object can then be downloaded to the device from online to compile information about non-compliance baseline images for later comparison with the then current condition of the object. To process and use this information, damage/improvement detection and visualization module 210 may include components capable of performing image recognition techniques including highlight damage module 212, visual overlay module 214, and instant feedback module 216. When the noncomplying feature is identified, repair guidance module 220 may analyze and associate additional information using damage severity module 222, repair expertise module 224, and alerting module 226. Damage severity module 222 provides a severity level for noncomplying feature 205 to inform user 102 of how imperative performing a corrective action is. Repair expertise module 224 determines a skill set or skill level required to perform the corrective action for comparing to user expertise. Expertise may include factors such as specialized equipment and tools as compared to what items are currently in an inventory of user assets. Alerting module 224 creates a recommendation that includes severity and expertise required. When DIY repair is recommended, alerting module 224 includes repair or corrective procedure information associated with the corrective action. When DIY repair is not recommended, repair option recommender 230 provides additional information using identify repair services module 232, cost estimation module 234, and recommendation module 236. As illustrated in FIGS. 3-6, DDRR module 125 generates and outputs first notification 260 to guide user 102.

With particular reference to FIG. 1A, according to aspects of the present disclosure, electronic system 105 includes image capturing device 152 having a field of view. Electronic system 105 includes electronic device 100 having memory 120 including: (i) damage detection/repair recommendation (DDRR) module 125; and (ii) data repository 251 (FIG. 2A (e.g., image repository) of tracked objects. Processor 112 of electronic device 100 is communicatively coupled to memory 120, image capturing device 152, and at least one output device 160. Processor 112 is configured to cause electronic system 105 to receive an image from image capturing device 152. Processor 112 is configured to cause electronic system 105 to identify, based on a comparison of the received image with one or more images within data repository 251 of tracked objects 203 (FIG. 2A), at least one tracked object 203 contained in the image received from image capturing device 152. In response to identifying at least one tracked object 203, processor 112 is configured to cause electronic system 105 to compare features of the image of at least one tracked object 203 to a baseline image for at least one tracked object 203. In response to identifying a noncomplying feature of the image from the baseline image, processor 112 is configured to cause electronic system 105 to select a corrective action to associate with the noncomplying feature. Processor 112 is configured to cause electronic system 105 to generate and output to at least one output device, a first notification comprising the corrective action to the noncomplying feature.

With particular reference to FIG. 2A, electronic system 105 includes AR device 106 having image capturing device 252 and at least one output device 160 (FIG. 1A) including at least one transmissive display 161a. At least one transmissive display 161a is configured to be positioned in front of at least one eye of user 102 while AR device 106 is being used/worn by user 102. At least one transmissive display 161a is configured to display first notification 260 while user 102 is viewing field of view 201a through at least one transmissive display 161a.

With particular reference to FIG. 2B, image capturing device is integrated within electronic device 100. At least one output device 160 (FIG. 1A) includes at least one display 161a communicatively coupled to processor 112. Processor 112 is further configured to cause electronic system 105 to generate and render first notification 260 (FIG. 2A) including visual content indicating the corrective action combined with the image. Processor 112 is further configured to cause electronic system 105 to present, via at least one display 161, first notification 260 combined with the image. In one or more embodiments, electronic device 100 is or constitutes electronic system 105.

With particular reference to both FIGS. 2A-2B, in one or more embodiments, electronic system 105a or 105b includes microphone 153a or 153 communicatively coupled to processor 112. Processor 112 is further configured to cause electronic system 105a or 105b to receive an audio signal from microphone 153a or 153. Processor 112 is further configured to cause electronic system 105a or 105b to compare the audio signal to a sound profile associated with at least one tracked object 203. Processor 112 is further configured to cause electronic system 105a or 105b to associate the corrective action to the noncomplying feature based at least in part on a result of the comparison of the audio signal to the sound profile. The baseline sound profile may be previously locally recorded or characterized when tracked object 203 did not include noncomplying feature 205. Alternatively, the baseline sound profile may be retrieved as part of public data 248.

With particular reference to FIG. 1A, in one or more embodiments, processor 112 is further configured to cause electronic system 105 to associate a severity of the noncomplying feature and generate the first notification indicating the corrective action and the severity of the noncomplying feature. In one or more embodiments, in associating the corrective action to the noncomplying feature, processor 112 is further configured to cause electronic system 105 to identify a required level of expertise associated with performing the corrective action. In response to determining that user 102 of electronic system 105 has at least the required level of expertise (e.g., by evaluating information within the user profile and/or the recommendations for repair posted online for the particular type of corrective action required), processor 112 is further configured to cause electronic system 105 to generate the first notification indicating a repair procedure to perform the corrective action.

In one or more embodiments, in associating the corrective action to the noncomplying feature, processor 112 is further configured to cause electronic system 105 to identify one or more provider(s) of the corrective action that includes or constitutes a repair service. Processor 112 is further configured to cause electronic system 105 to rank the one or more provider(s) based on one or more preference factors from a group including, but not necessarily limited to: (i) cost; (ii) distance; (iii) availability; (iv) customer reviews; and (v) current or past affiliation. Processor 112 is further configured to cause electronic system 105 to generate the first notification indicating the corrective action including the repair service and at least one provider of the one or more provider(s) having a top/highest ranking. In one or more particular embodiments, processor 112 is further configured to cause electronic system 105 to autonomously book an appointment with the at least one provider having the top ranking.

In one or more particular embodiments, in associating the corrective action to the noncomplying feature, processor 112 is further configured to cause electronic system 105 to determine an estimated cost associated with the repair service to perform the corrective action. Processor 112 is further configured to cause electronic system 105 to generate the first notification indicating the corrective action including the estimated cost along with attribution to a source of the estimated cost.

In one or more embodiments, the electronic system 105, further includes artificial intelligence (AI) engine 115. Processor 112 is configured to cause electronic system 105 to identify the at least one tracked object and the noncomplying feature using AI engine 115 trained using one or more images corresponding to the at least one tracked object.

In one or more embodiments, in response to detecting a trigger indicating user tagging/selecting of an object contained in the image captured in the FOV of the camera, processor 112 is further configured to cause electronic system 105 to perform image recognition of the object to identify a new tracked object. Processor 112 is configured to cause electronic system 105 to associate at least one baseline image with the new tracked object. Processor 112 is configured to cause electronic system 105 to add at least one of the object contained in the image and the at least one baseline image to the image repository of tracked objects.

In one or more embodiments, in associating the corrective action to the noncomplying feature, processor 112 is configured to cause electronic system 105 to determine and associate a severity of the noncomplying feature. In an example, the size and image characteristics may be compared to baseline images of noncomplying features 205, such that smaller defects may have a lower severity. In another example, the type of noncomplying feature 205 is associated with a particular severity level based on the function that is impaired or degraded. Processor 112 is configured to cause electronic system 105 to identify a required level of expertise associated with performing the corrective action. Processor 112 is configured to cause electronic system 105 to determine whether user 102 of electronic system 105 has at least the required level of expertise to perform the corrective action. Processor 112 is configured to cause electronic system 105 to generate the first notification indicating: (i) the corrective action; (ii) the severity of the noncomplying feature; (iii) a recommended one or more of user 102 and a repair service provider performing the corrective action based on a comparison of the required level of expertise and the level of expertise of user 102; and (iv) an estimated cost of the corrective action.

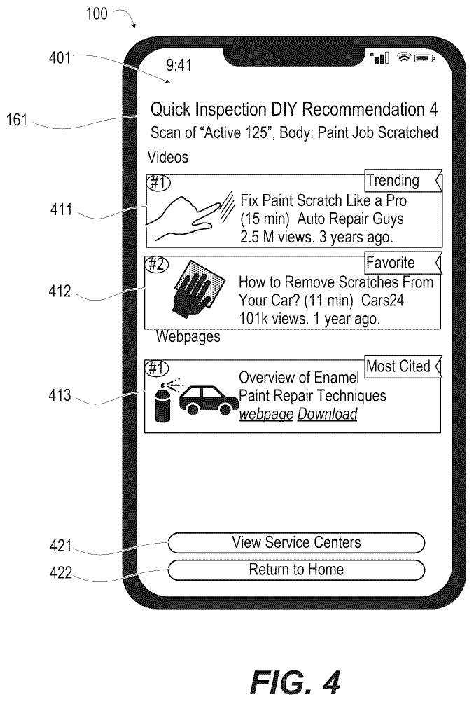

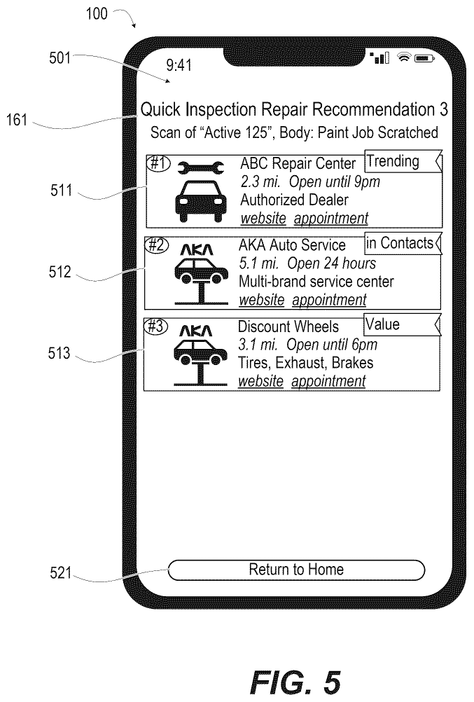

FIG. 3 illustrates display 161 of electronic device 100 presenting quick scan results window 301 that includes camera preview 302 of tracked object 303 (e.g., a motor scooter). Electronic device 100 detects noncomplying features 311-314 that are annotated on camera preview 302, such as using callouts “1”, “2”, “3” and “4” that correspond respectively to notifications 321-324, each having corresponding assessments 331-334 for severity and recommended corrective actions 341-344. In an example, noncomplying feature 311 is a cracked rearview mirror. Notification 321 further identifies the noncomplying feature 311 and provides assessment 331 of “moderate-safety related” and recommended corrective action 341 of “non-urgent repair”. Noncomplying feature 312 is a detached clutch cable. Notification 322 further identifies the noncomplying feature 312 and provides assessment 332 of “High-operability” and recommended corrective action 342 of “DIY urgent repair”. Noncomplying feature 313 is a scratched paint job. Notification 323 further identifies the noncomplying feature 313 and provides assessment 333 of “Low-cosmetic” and recommended corrective action 343 of “optional DIY”. Noncomplying feature 314 is a deflated tire/possible puncture. Notification 324 further identifies the noncomplying feature 314 and provides assessment 334 of “High-operability” and recommended corrective action 344 of “urgent repair”. In an example, user 102 may trigger recommended corrective action 343 to obtain additional information about DIY corrective actions as described below with regard to FIG. 4. In another example, user 102 may trigger recommended corrective action 344 to obtain additional information regarding service providers as described below with regard to FIG. 5.

FIG. 4 illustrates display 161 of electronic device 100 presenting recommended do-it-yourself repair procedures window 401 for accomplishing recommended corrective action 343 (FIG. 3). In an example, electronic device 100 has associated and ranked three sources of information for DIY repair of scratched enamel paint on a vehicle. First recommended repair procedure 411 is a video that is identified as trending with a large number of viewers. Second recommended repair procedure 412 is a video that is identified as a favorite website of user 102 (FIG. 1A). Third recommended repair procedure 413 is a webpage that is identified as being most frequently cited by other webpages. Recommended do-it-yourself repair procedures window 401 includes controls such as view service center control 421 to switch from DIY options to providers of repair services. Recommended do-it-yourself repair procedures window 401 also includes controls such as return to home control 422. Recommended repair procedures 411, 412 and 413 may include selectable controls to open additional popups, windows, or display segments containing additional information and options. In an example, the selectable controls may assist in procuring needed supplies and tools to perform a corrective action.

FIG. 5 illustrates display 161 of electronic device 100 presenting recommended providers window 501 of recommended corrective action 344 (FIG. 3). In an example, electronic device 100 has associated and ranked three websites for providers of repair services for a deflated/punctured tire of a motor scooter. First provider notification 511 identifies first provider that was identified based on a trending number of views and based on being nearby and open. Second provider notification 512 identifies a second provider that is a little further away and open and is in contacts stored on electronic device 100. Third provider notification 513 identifies a value provider based on estimated cost, proximity, user reviews, and being open. Recommended provider window 501 also includes controls such as return to home control 521. Recommended provider notifications 511, 512 and 513 may include selectable controls to open additional popups, windows, or display segments containing additional information and options. In an example, the selectable controls may link to provider contact systems or initiate automated scheduling of services.

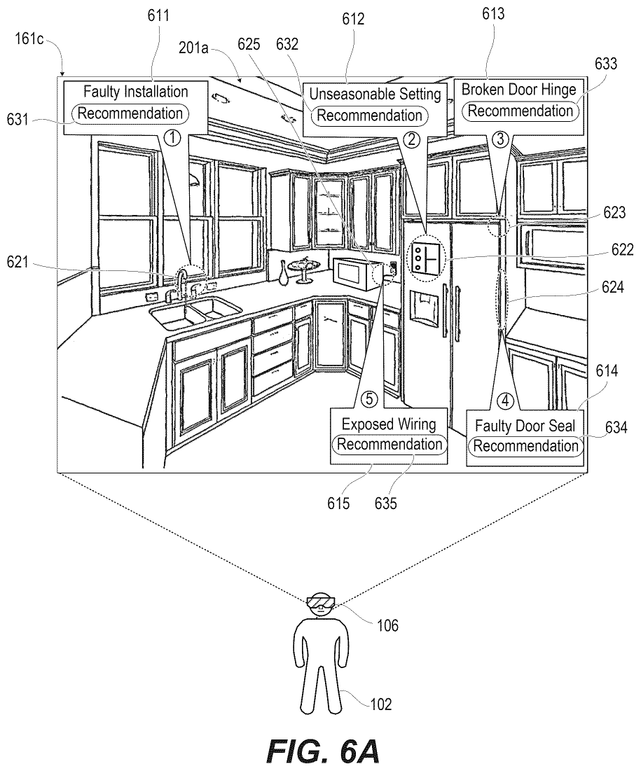

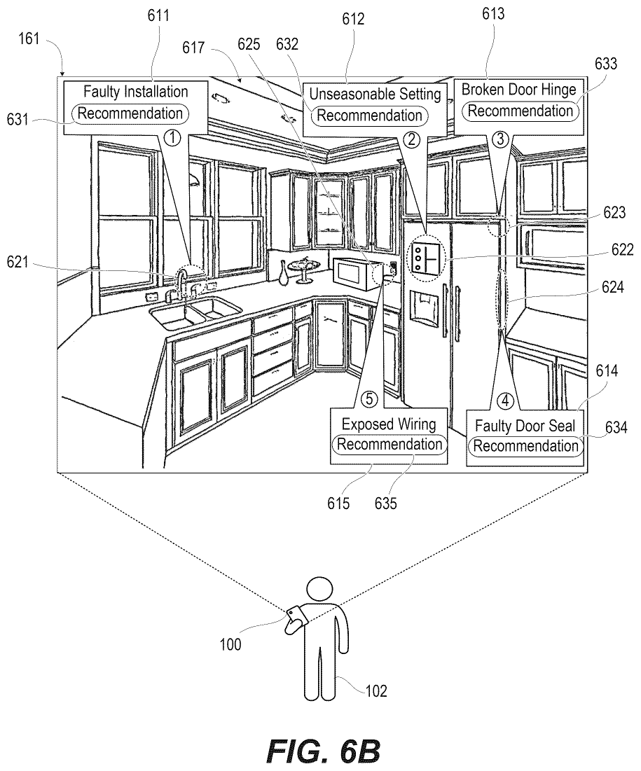

FIG. 6A illustrates transmissive display 161c of AR device 106 of electronic system 105 presenting notifications 611-615 overlaid on field of view 201a correspond to tracked objects 621-625 identified as having noncomplying features. First tracked object 621 is a kitchen faucet that is viewable with first notification 611 indicating faulty installation as the noncomplying feature. Second tracked object 622 is a refrigerator control that is viewable with second notification 612 indicating improper settings as the noncomplying feature. In an example, an appliance may be placed in a location exposed to different temperature and humidity conditions at different seasons of the year. Temperature settings or operational use may require adjustment to correspond to the season. In another example, the settings may indicate a diagnostic or other nonoperative mode that is inappropriate for proper functioning. Third tracked object 623 is a refrigerator door hinge that is viewable with third notification 613 indicating a broken hinge as the noncomplying feature. Fourth tracked object 624 is a refrigerator door seal that is viewable with fourth notification 614 indicating a faulty door seal as the noncomplying feature. Fifth tracked object 625 is a toaster oven that is viewable with fifth notification 615 indicating an exposed electrical wiring as the noncomplying feature. User 102 may trigger respective recommendations 631, 632, 633, 634 and 635 corresponding to each notification 611-615 to obtain additional information, such as described above with regard to FIGS. 3-5.

FIG. 6B illustrates display 161 of electronic device 100 presenting notifications 611 615 overlaid on camera preview 617 of tracked objects 621-625. User 102 may position electronic device 100 in a manner similar to a heads-up display, pointing back image capturing device 152b towards an area captured by the corresponding field of view and viewing display 161 (FIG. 1A). Camera preview 617 may simulate a transmissive display such as AR device 106 (FIG. 6A) as user 102 orients back image capturing device 152b while viewing display 161. User 102 may interact with notifications by touch, eye gaze direction, gesture, audible commands, muscle twitch sensing for the disabled, etc.

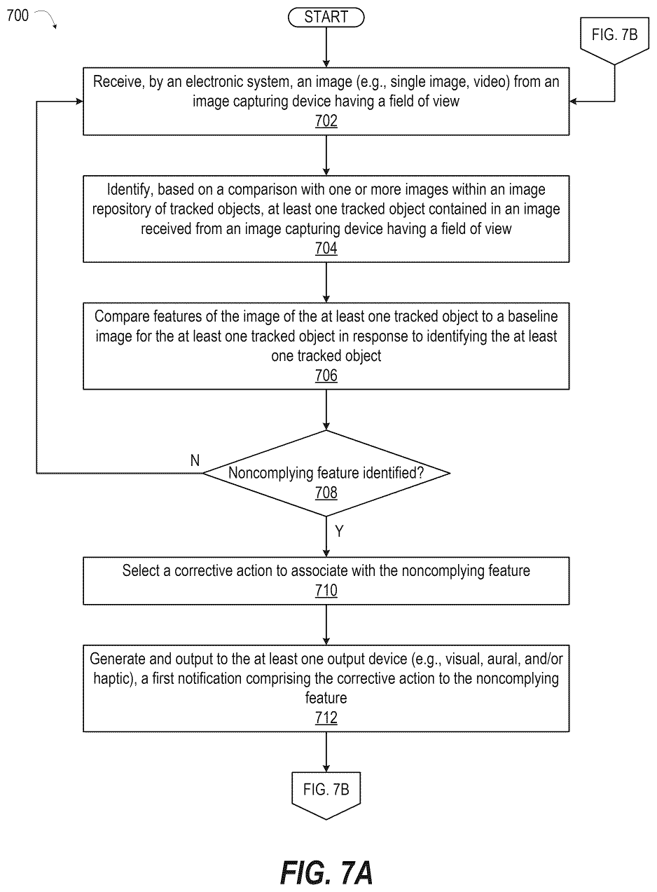

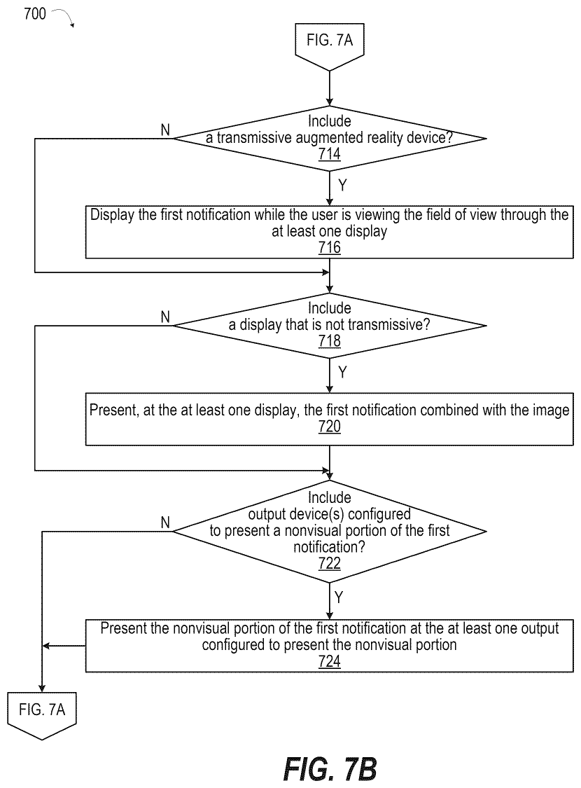

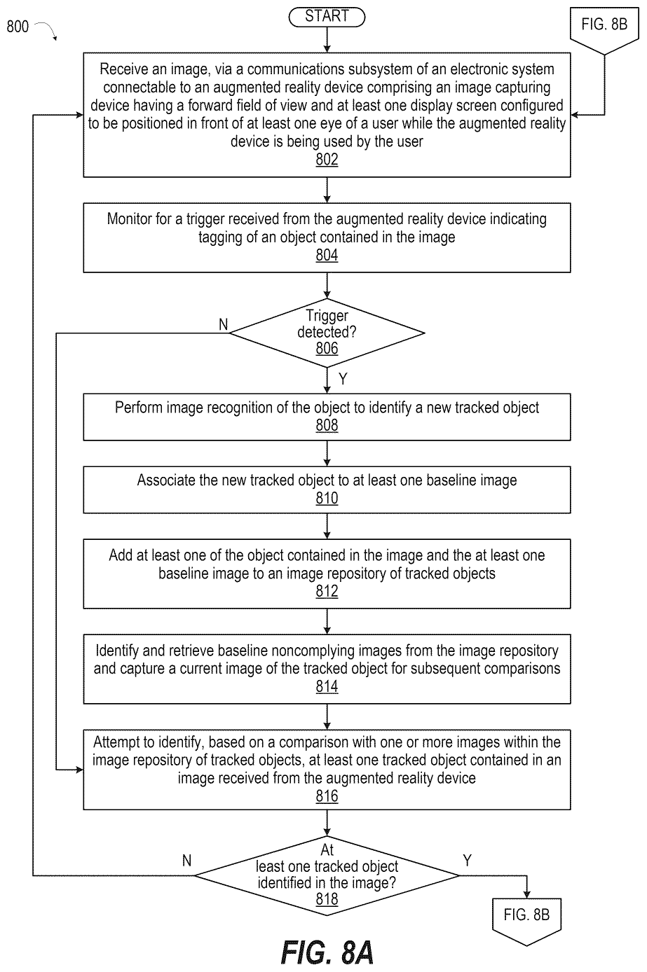

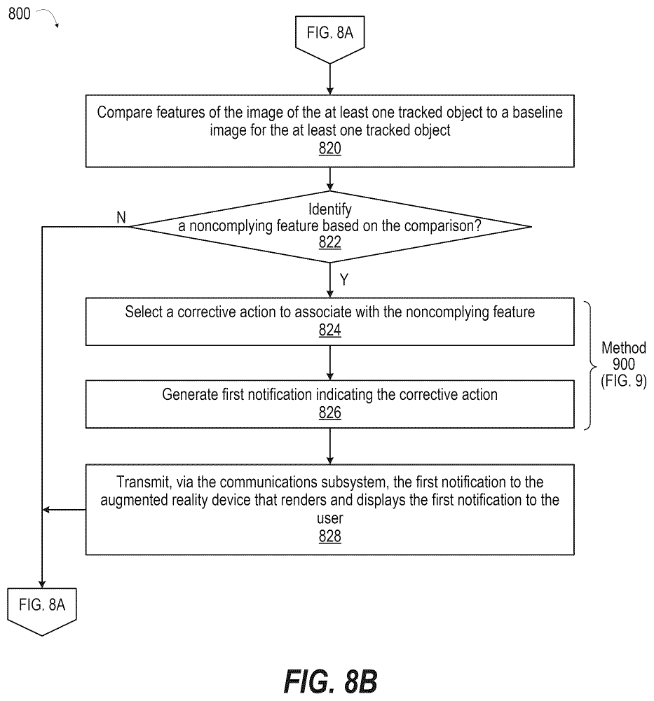

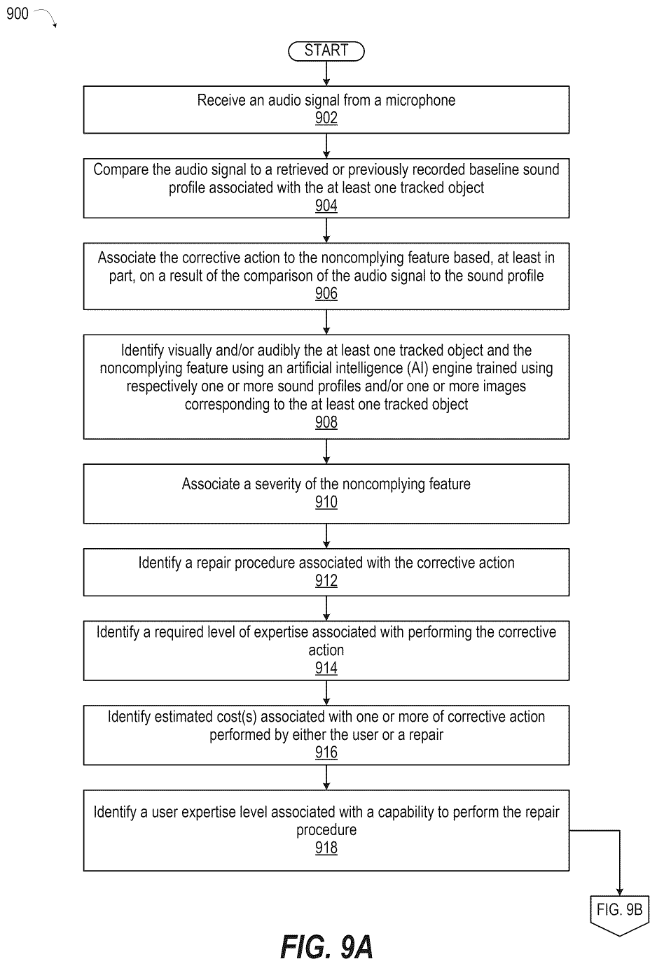

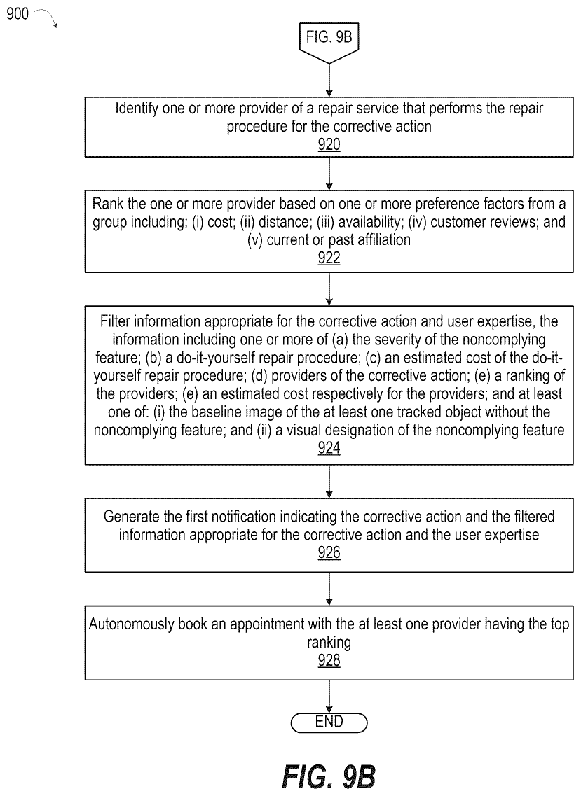

FIGS. 7A-7B (collectively “FIG. 7”) is a flow diagram presenting computer-implemented method 700 for recognizing nonconforming or noncomplying features (e.g., improper installation, damage) of objects tagged for monitoring and for recommending corrective actions to a user to address the noncomplying features. FIGS. 8A-8B (collectively “FIG. 8”) is a flow diagram presenting computer-implemented method 800 augmenting method 700 (FIG. 7) with a plurality of techniques for recognizing noncomplying features and recommending corrective actions via an AR device. FIGS. 9A-9B (collectively “FIG. 9”) is a flow diagram presenting computer-implemented method 900 augmenting method 800 (FIG. 8) with techniques for selecting a corrective action and generating a notification indicating the corrective action. The descriptions of method 700 (FIG. 7), method 800 (FIG. 8), and method 900 (FIG. 9) are provided with general reference to the specific components illustrated within the preceding FIGS. 1A-1B, 2A-2B, and 3-6. Specific components referenced in method 700 (FIG. 7), method 800 (FIG. 8), and method 900 (FIG. 9) may be identical or similar to components of the same name used in describing preceding FIGS. 1A-1B, 2A-2B , and 3-6. In one or more embodiments, controller 110 (FIG. 1A) configures electronic device 100 (FIGS. 1A-1B) or a similar computing device to provide the described functionality of method 700 (FIG. 7), method 800 (FIG. 8), and method 900 (FIG. 9).

With reference to FIG. 7A, method 700 includes receiving, by an electronic system, an image (e.g., single image, video) from an image capturing device having a field of view of a monitored area/object (block 702). Method 700 includes identifying, based on a comparison with one or more images within an image repository of tracked objects, at least one tracked object contained in the image received from the image capturing device (block 704). Method 700 includes, in response to identifying the at least one tracked object, comparing features of the image of the at least one tracked object to a baseline image for the at least one tracked object (block 706). Method 700 includes determining whether a noncomplying feature of the image is identified based on the comparison with the baseline image (decision block 708). In response to not identifying any noncomplying feature of the image, method 700 returns block 702. In response to identifying a noncomplying feature of the image from the baseline image, method 700 includes selecting a corrective action to associate with the noncomplying feature (block 710). Method 700 includes generating and outputting to at least one output device (e.g., visual, aural, and/or haptic), a notification comprising the corrective action to the noncomplying feature (block 712).

In one or more embodiments, method 700 includes determining whether the electronic system includes an AR device (e.g., smart glasses or heads up display) (decision block 714). The AR device has the image capturing device and has the at least one output device that includes at least one transmissive display configured to be positioned in front of at least one eye of a user while the AR device is being used/worn by the user. The user may see a real-world view that matches at least a portion of the field of view of the image capturing device. The real-world view matches at least a portion of the image captured by the image capturing device. In response to determining that the electronic system includes an AR device with a transmissive display, method 700 includes displaying the notification while the user is viewing the field of view through the at least one transmissive display (block 716).

In response to determining that the electronic system does not include an augmented reality device in decision block 714 or after performing display the notification in block 716, method 700 includes determining whether the electronic system has an electronic device (e.g., smartphone or tablet computer) with one or more output devices including a normal display (i.e., one that is not transmissive) (decision block 718). In response to determining that the electronic system includes the electronic device with the display, method 700 includes presenting, at the at least one display, the notification superimposed on and/or combined with the image (block 720). In response to determining that the electronic system does not include a display in decision block 718 or after presenting the notification with the image in block 720, method 700 includes determining whether the electronic system includes at least one output device configured to present a nonvisual notification (block 722). In response to determining that the electronic system includes at least one output device (e.g., a speaker) configured to present a nonvisual notification (e.g., an audible notification), method 700 includes presenting the nonvisual notification at the at least one output device configured to present the nonvisual notification (block 724). In response to determining that the electronic system does not include at least one output device configured to present a nonvisual notification in decision block 722 or after presenting the nonvisual notification in block 724, method 700 returns to block 702. It is appreciated that in some embodiments, both a visual notification and a non-visual (e.g., audible) notification can be presented simultaneously/concurrently by the device to ensure the user is made aware of the need for the corrective action. As an example, an audible notification may be presented concurrently with the visual notification for detected conditions that fall within a category of conditions that require urgent attention.

Referring now to FIG. 8A, method 800 includes receiving an image of a field of view of an image capturing device of an AR device (block 802). The image is received via a communications subsystem of an electronic device that is connected to the AR device. The AR device has a forward field of view and at least one display screen configured to be positioned in front of at least one eye of a user while the AR device is being used/worn by the user. Method 800 includes monitoring for a trigger received from the AR device indicating user tagging of an object contained in the image (block 804). In an example, the user gazes at the object, causing the electronic device to visually identify and to annotate the object. Then the user verbally provides an instruction to tag the object. Method 800 includes determining whether a trigger is detected indicating tagging of an object contained in the image (decision block 806). In response to detecting a trigger indicating tagging of an object contained in the image, method 800 includes performing image recognition of the object to identify a new tracked object (block 808). Method 800 includes identifying and associating at least one baseline image for the new tracked object (block 810). Method 800 includes adding at least one of the object contained in the image and the at least one baseline image to an image repository of tracked objects (block 812). In response to not detecting, in decision block 806, a trigger indicating tagging of an object contained in the image or after adding an image to the image repository in block 812, method 800 may include identifying and retrieving baseline noncomplying images from the image repository and capturing a current image of the tracked object for subsequent comparisons (block 814).

Method 800 includes attempting to identify, based on a comparison with one or more images within the image repository of tracked objects, at least one tracked object contained in an image received from the AR device (block 816). Method 800 includes determining whether at least one tracked object is identified in the image (decision block 818). In response to not identifying the at least one tracked object, method 800 returns to block 802. In response to identifying the at least one tracked object, method 800 proceeds to block 820 of FIG. 8B.

With reference to FIG. 8B, method 800 includes comparing features of the image of the at least one tracked object to a baseline image for the at least one tracked object (block 820). Method 800 includes selecting a noncomplying feature based on the comparison (decision block 822). In response to not identifying a noncomplying feature of the image from the baseline image, method 800 returns to block 802 of FIG. 8B. In response to identifying a noncomplying feature of the image from the baseline image, method 800 includes selecting a corrective action to associate with the noncomplying feature (block 824). Method 800 includes generating a first notification indicating the corrective action (block 826). Method 800 includes transmitting, via the communications subsystem, the first notification to the AR device that renders and displays, to the user, the first notification superimposed over, connected to, or otherwise associated with the tracked object (block 828). Then method 800 returns to block 802 of FIG. 8B.

With reference to FIG. 9A, method 900 includes receiving an audio signal from a microphone (block 902). Method 900 includes comparing the audio signal to a retrieved or previously recorded baseline sound profile associated with the at least one tracked object (block 904). In an example, method 900 may include capturing the baseline sound profile of the tagged object when initially tagged. Alternatively, or in addition, method 900 may include identifying and retrieving the baseline sound profile from a data repository. Alternatively, or in addition, method 900 may include retrieving baseline noncomplying sound profiles from the data repository for comparison to a current sound profile to identify a noncomplying feature. In one or more embodiments, a current sound profile may provide a sole basis for identifying a noncomplying feature that is not visible without disassembly or repositioning of the tracked object. Method 900 may include associating the corrective action to the noncomplying feature based, at least in part, on a result of the comparison of the audio signal to the sound profile (block 906). Method 900 may include identifying visually and/or audibly the at least one tracked object and the noncomplying feature using an artificial intelligence (AI) engine trained using respectively one or more sound profiles and/or one or more images corresponding to the at least one tracked object (block 908). Method 900 includes associating a severity of the noncomplying feature (block 910). Method 900 may include identifying a repair procedure associated with the corrective action (block 912). Method 900 includes identifying a required level of expertise associated with performing the corrective action (block 914). In an example, the noncomplying feature may be an unplugged electrical device for which do it yourself corrective action is the only appropriate corrective action. In another example, the noncomplying feature may be malfunction of component for which scarce, expensive and/or difficult to use repair equipment is required, necessitating a repair service and not do it yourself repair. In an additional example, the corrective action may be within the capabilities of at least some users and is also available to be completed by service providers. Method 900 includes identifying estimated cost(s) associated with one or more of corrective action performed by either the user or a repair service provider (block 916). Then method 900 proceeds to block 920 of FIG. 9B.

With reference to FIG. 9B, method 900 includes identifying a user expertise level associated with a capability to perform the repair procedure (block 918). Method 900 includes identifying one or more provider of a repair service that performs the repair procedure for the corrective action (block 920). Method 900 includes ranking the one or more provider based on one or more preference factors from a group comprising: (i) cost; (ii) distance; (iii) availability; (iv) customer reviews; and (v) current or past affiliation (block 922). Method 900 includes filtering information appropriate for the corrective action and user expertise, the information including one or more of (a) the severity of the noncomplying feature; (b) a do-it-yourself repair procedure; (c) an estimated cost of the do-it-yourself repair procedure; (d) providers of the corrective action; (e) a ranking of the providers; (e) an estimated cost respectively for the providers; and at least one of: (i) the baseline image of the at least one tracked object without the noncomplying feature; and (ii) a visual designation of the noncomplying feature (block 924). Method 900 includes generating the first notification indicating the corrective action and the filtered information appropriate for the corrective action and the user expertise (block 926). Method 900 may include autonomously booking an appointment with the at least one provider having the top ranking (block 928). Then method 900 ends.

In one or more embodiments, method 900 may further include presenting a user interface (UI) for setting up the features of the present disclosure that allows the user to select the automatic contacting of the service provider. Alternatively, the setup UI can allow for the notification to be shared with another person, such as a spouse or a parent who handles such repairs. In one implementation, the user of the AR device is not the one whose profile is added to the device. For example, a son or daughter may be the user who wears the AR device around the house, but it is the parent who is responsible for fixing or getting issues fixed. The profile of the responsible user is entered for DIY projects and a corresponding electronic device (e.g., smartphone) of the responsible user receives the copy of the notification of the issue detected.

According to aspects of the present disclosure, method 900 may include identifying, based on a comparison with one or more images within an image repository of tracked objects, at least one tracked object contained in an image received within a field of view of an image capturing device. When a user wears an augmented reality device, at least one eye of the user sees a real-world view that matches at least a portion of the field of view of the image capturing device. In response to identifying the at least one tracked object, method 900 may include comparing features of the image of the at least one tracked object to a baseline image for the at least one tracked object. In response to identifying a noncomplying feature of the image from the baseline image, method 900 may include selecting a corrective action to associate with the noncomplying feature. The noncomplying feature has to be assessed as having an appreciable or even a significant impact to aesthetics, function, safety and operation. Method 900 may include generating and outputting, to at least one output device, a first notification including the corrective action to the noncomplying feature.

In one or more embodiments, method 900 may further include generating and outputting the first notification including at least one of: (i) the baseline image of the at least one tracked object without the noncomplying feature; and (ii) a visual designation of the noncomplying feature. In one or more embodiments, method 900 may further include generating and outputting the first notification to a transmissive display of an AR device. The transmissive display is configured to display the first notification while the user is viewing the field of view through the transmissive display.

In one or more embodiments, method 900 may further include generating and rendering the first notification including visual content indicating the corrective action combined with the image. Method 900 may further include presenting, at the at least one output device comprising at least one display, the first notification combined with the image.

In one or more embodiments, method 900 may further include receiving an audio input via a microphone concurrently with receiving the image containing an object being monitored/tracked. Method 900 may further include identifying the audio input as originating from the tracked object. Method 900 may further include comparing the audio signal to a sound profile associated with the at least one tracked object. Method 900 may further include associating the corrective action to the noncomplying feature based at least in part on a result of the comparison of the audio signal to the sound profile indicating the presence of a particular audio-related noncomplying feature.

In one or more embodiments, method 900 may further include determining/evaluating and associating a severity to the noncomplying feature. Method 900 may further include generating the first notification indicating the corrective action and the severity of the noncomplying feature.

In one or more embodiments, method 900 may further include associating the corrective action to the noncomplying feature by identifying a required level of expertise associated with performing the corrective action. In response to determining that a user of an electronic system has at least the required level of expertise, method 900 may further include generating the first notification indicating a repair procedure for the user to perform the corrective action.

In one or more embodiments, method 900 may further include associating the corrective action to the noncomplying feature by identifying one or more provider(s) of the corrective action, comprising a repair service. Method 900 may further include ranking the one or more provider(s) based on one or more preference factors from a group comprising: (i) cost; (ii) distance; (iii) availability; (iv) customer reviews; and (v) current or past affiliation. Method 900 may further include generating the first notification indicating the corrective action comprising the repair service and at least one provider of the one or more provider having a top ranking. In one or more specific embodiments, method 900 may further include autonomously booking an appointment with the at least one provider having the top ranking.

In one or more particular embodiments, method 900 may further include associating the corrective action to the noncomplying feature by associating an estimated cost associated with the repair service to perform the corrective action. Method 900 may further include generating the first notification indicating the corrective action comprising the estimated cost with attribution to a source of the estimated cost.

In one or more particular embodiments, method 900 may further include identifying the at least one tracked object and the noncomplying feature using an artificial intelligence (AI) engine trained using one or more images corresponding to the at least one tracked object.

In one or more embodiments, method 900 may further include performing image recognition of the object to identify a new tracked object. Method 900 may further include associating the new tracked object to at least one baseline image. Method 900 may further include adding at least one of the object contained in the image and the at least one baseline image to the image repository of tracked objects.

In one or more embodiments, method 900 may further include associating the corrective action to the noncomplying feature by associating a severity of the noncomplying feature. Method 900 may further include identifying a required level of expertise associated with performing the corrective action. Method 900 may further include determining whether a user of an electronic system has at least the required level of expertise to perform the corrective action. Method 900 may further include generating the first notification indicating the corrective action, the severity of the noncomplying feature, a recommended one or more of the user and a repair service provider performing the corrective action based on a comparison of the required level of expertise and the level of expertise of the user, and an estimated cost of the corrective action.

According to aspects of the present disclosure, the electronic device 100 (FIG. 1A), method 700 (FIG. 7), method 800 (FIG. 8), method 900 (FIG. 9), and computer program product, such as RSD 145 (FIG. 1A), provide techniques for recognizing nonconforming or noncomplying features (e.g., improper installation, damage) of objects tagged for monitoring and for recommending corrective actions to a user to address the noncomplying features. The user may not be sufficiently observant or knowledgeable to identify the noncomplying feature. Alternatively, or in addition, the user may be insufficiently knowledgeable to know the corrective action required for the noncomplying feature. In an example, the user may not know a repair procedure that is the corrective action. In another example, the user may not know a provider of the repair procedure, or a particular provider of the repair procedure that should be contacted. The automated features of the present disclosure assist users in identifying and correcting issues with tracked objects even when the user is unaware that assistance is needed.

Aspects of the present innovation are described above with reference to flowchart illustrations and/or block diagrams of methods, apparatus (systems) and computer program products according to embodiments of the innovation. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

As will be appreciated by one skilled in the art, embodiments of the present innovation may be embodied as a system, device, and/or method. Accordingly, embodiments of the present innovation may take the form of an entirely hardware embodiment or an embodiment combining software and hardware embodiments that may all generally be referred to herein as a “circuit,” “module” or “system.”

While the innovation has been described with reference to exemplary embodiments, it will be understood by those skilled in the art that various changes may be made, and equivalents may be substituted for elements thereof without departing from the scope of the innovation. In addition, many modifications may be made to adapt a particular system, device, or component thereof to the teachings of the innovation without departing from the essential scope thereof. Therefore, it is intended that the innovation not be limited to the particular embodiments disclosed for carrying out this innovation, but that the innovation will include all embodiments falling within the scope of the appended claims. Moreover, the use of the terms first, second, etc., do not denote any order or importance, but rather the terms first, second, etc. are used to distinguish one element from another.

The terminology used herein is for the purpose of describing particular embodiments only and is not intended to be limiting of the innovation. As used herein, the singular forms “a”, “an” and “the” are intended to include the plural forms as well, unless the context clearly indicates otherwise. It will be further understood that the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present innovation has been presented for purposes of illustration and description but is not intended to be exhaustive or limited to the innovation in the form disclosed. Many modifications and variations will be apparent to those of ordinary skill in the art without departing from the scope and spirit of the innovation. The embodiments were chosen and described in order to best explain the principles of the innovation and the practical application, and to enable others of ordinary skill in the art to understand the innovation for various embodiments with various modifications as are suited to the particular use contemplated.

1. An electronic system, comprising:
an image capturing device having a field of view;
a memory comprising: (i) program code for a repair condition detection and repair recommendation (RCDRR) module; and (ii) an image repository of tracked objects; and
a processor communicatively coupled to at least one output device, the image capturing device, and the memory, and which is configured to cause the electronic system to:
receive an image from the image capturing device having a field of view;
monitor for a trigger indicative of user tagging of an object contained within the image;
in response to detecting the trigger: perform image recognition of the object to identify the object as a new tracked object; associate the new tracked object with a baseline image; and add the baseline image of the new tracked object to the image repository of tracked objects;
identify, based on a comparison of a received image with one or more images within the image repository of tracked objects, a tracked object contained in an image received from the image capturing device;
in response to identifying the tracked object, compare features of the image of the tracked object to a baseline image for the tracked object to identify noncomplying features; and
in response to identifying a noncomplying feature of the image from the baseline image:
select a corrective action to associate with the noncomplying feature; and
generate and output, to at least one output device, a first notification comprising the corrective action to the noncomplying feature.

2. The electronic system of claim 1, further comprising an augmented reality device comprising the image capturing device and the at least one output device comprising at least one display configured to be positioned in front of at least one eye of a user while the augmented reality device is being used by the user, the at least one display configured to display the first notification while the user is viewing the field of view through the at least one display.

3. The electronic system of claim 1, wherein the at least one output device comprises at least one display communicatively coupled to the processor, and wherein the processor is further configured to cause the electronic system to:
generate and render the first notification comprising visual content indicating the corrective action combined with the image; and
present, at the at least one display, the first notification combined with the image.

4. The electronic system of claim 1, further comprising a microphone communicatively coupled to the processor, and wherein the processor is further configured to cause the electronic system to:
receive an audio signal from the microphone;
compare the audio signal to a sound profile associated with the at least one tracked object; and
associate the corrective action to the noncomplying feature based at least in part on a result of the comparison of the audio signal to the sound profile.

5. The electronic system of claim 1, wherein the processor is further configured to cause the electronic system to:
associate a severity of the noncomplying feature; and
generate the first notification indicating the corrective action and the severity of the noncomplying feature.

6. The electronic system of claim 1, wherein, in associating the corrective action to the noncomplying feature, the processor is further configured to cause the electronic system to:
identify a required level of expertise associated with performing the corrective action; and
in response to determining that a user of the electronic system has at least the required level of expertise, generate the first notification indicating a repair procedure to perform the corrective action.

7. The electronic system of claim 1, wherein, in associating the corrective action to the noncomplying feature, the processor is further configured to cause the electronic system to:
identify one or more provider of the corrective action, comprising a repair service;
associate an estimated cost associated with the repair service to perform the corrective action;
rank the one or more provider based on one or more preference factors from a group comprising: (i) cost; (ii) distance; (iii) availability; (iv) customer reviews; and (v) current or past affiliation; and
generate the first notification indicating the corrective action comprising the repair service and the estimated cost with attribution to a source of the estimated cost, and at least one provider of the one or more provider having a top ranking.

8. (canceled)

9. The electronic system of claim 7, wherein the processor is further configured to cause the electronic system to autonomously book an appointment with the at least one provider having the top ranking.

10. The electronic system of claim 1, further comprising an artificial intelligence (AI) engine, wherein the processor is configured to cause the electronic system to:
identify the at least one tracked object and the noncomplying feature using the AI engine trained using one or more images corresponding to the at least one tracked object.

11. (canceled)

12. The electronic system of claim 1, wherein, in associating the corrective action to the noncomplying feature, the processor is further configured to cause the electronic system to:
associate a severity of the noncomplying feature;
identify a required level of expertise associated with performing the corrective action;
determine whether a user of the electronic system has at least the required level of expertise to perform the corrective action; and
generate the first notification indicating the corrective action, the severity of the noncomplying feature, a recommended one or more of the user and a repair service provider performing the corrective action, based on a comparison of the required level of expertise and the level of expertise of the user and an estimated cost of the corrective action.

13. A method, comprising:
receiving an image from the image capturing device having a field of view;
monitoring for a trigger indicative of user tagging of an object contained within the image;
in response to detecting the trigger: performing image recognition of the object to identify the object as a new tracked object; associating the new tracked object with a baseline image; and adding the baseline image of the new tracked object to the image repository of tracked objects;
identifying, based on a comparison of a received image with one or more images within an image repository of tracked objects, a tracked object contained in an image received from an image capturing device having a field of view;
in response to identifying the tracked object, comparing features of the image of the tracked object to a baseline image for the tracked object to identify noncomplying features; and
in response to identifying a noncomplying feature of the image from the baseline image:
selecting a corrective action to associate with the noncomplying feature; and
generating and outputting, to at least one output device, a first notification comprising the corrective action to the noncomplying feature.

14. The method of claim 13, further comprising:
generating and outputting, to an augmented reality device comprising the image capturing device and the at least one output device comprising at least one display configured to be positioned in front of at least one eye of a user while the augmented reality device is being used by the user, the at least one display configured to display the first notification while the user is viewing the field of view through the at least one display.

15. The method of claim 13, further comprising:
generating and rendering the first notification comprising visual content indicating the corrective action combined with the image; and
presenting, at the at least one output device comprising at least one display, the first notification combined with the image.

16. The method of claim 13, further comprising:
receiving an audio signal from a microphone;
comparing the audio signal to a sound profile associated with the at least one tracked object; and
associating the corrective action to the noncomplying feature based at least in part on a result of the comparison of the audio signal to the sound profile.

17. The method of claim 13, further comprising:
associating a severity to the noncomplying feature; and
generating the first notification indicating the corrective action and the severity of the noncomplying feature.

18. The method of claim 13, further comprising associating the corrective action to the noncomplying feature by:
identifying a required level of expertise associated with performing the corrective action; and
in response to determining that a user of an electronic system has at least the required level of expertise, generating the first notification indicating a repair procedure to perform the corrective action.

19. The method of claim 13, further comprising associating the corrective action to the noncomplying feature by:
identifying one or more provider of the corrective action, comprising a repair service;
associating an estimated cost associated with the repair service to perform the corrective action;
ranking the one or more provider based on one or more preference factors from a group comprising: (i) cost; (ii) distance; (iii) availability; (iv) customer reviews; (v) current or past affiliation; (vi) the estimated cost;
generating the first notification indicating the corrective action comprising the repair service and at least one provider of the one or more provider having a top ranking. with attribution to a source of the estimated cost; and
autonomously booking an appointment with the at least one provider having the top ranking.

20. A computer program product comprising:
a computer readable storage device; and
program code on the computer readable storage device that when executed by a processor associated with an electronic system, the program code is configured to cause the electronic system to provide functionality of:
receiving an image from the image capturing device having a field of view;
monitoring for a trigger indicative of user tagging of an object contained within the image;
in response to detecting the trigger: performing image recognition of the object to identify the object as a new tracked object; associating the new tracked object with a baseline image; and adding the baseline image of the new tracked object to the image repository of tracked objects;
identifying, based on a comparison of a received image with one or more images within an image repository of tracked objects, a tracked object contained in an image received from an image capturing device having a field of view;
in response to identifying the tracked object, comparing features of the image of the tracked object to a baseline image for the tracked object to identify noncomplying features; and
in response to identifying a noncomplying feature of the image from the baseline image:
selecting a corrective action to associate with the noncomplying feature; and
generating and outputting, to output device(s), a first notification comprising the corrective action to the noncomplying feature.

21. The electronic system of claim 1, wherein the processor is further configured to cause the electronic system to:
determine that the new tracked object is in a baseline condition; and
complete the association of the image of the new tracked object to the baseline image, in response to the new tracked object being in a baseline condition.

22. The electronic system of claim 1, further comprising:
a communications subsystem coupled to the processor;
wherein the processor is further configured to cause the electronic system to:
access one or networks via the communications subsystem to retrieve public data comprising available baseline images and noncomplying baseline images; and
add the available baseline images and the noncomplying baseline images to the image repository of tracked objects, the noncomplying baseline images utilized to identify noncomplying features.
